(19) United States
(12) Patent Application Publication
(10) Pub. No.: US 2024/0324495 A1
(43) Pub. Date: Oct. 3, 2024

(54) Spreader with Side Clasps

(71) Applicant: Andrew Brenden Laplante, Mount Laurel, NJ (US)

(72) Inventor: Andrew Brenden Laplante, Mount Laurel, NJ (US)

(21) Appl. No.: 18/198,380

(22) Filed: May 17, 2023

Related U.S. Application Data
(60) Provisional application No. 63/415,680, filed on Nov. 15, 2022.

(51) Int. Cl. A01C 15/00

(52) U.S. Cl. CPC A01C 15/005

(57) ABSTRACT

A peat moss and top-dressing spreader with side clasps designed to help distribute peat moss, compost, and other top-dressing materials with ease and efficiency. The spreader features a rotating drum that holds the material and a mesh-diamond cage barrel for optimal filtration, breaking up material clumps, and quick, consistent, and even distribution of top-dressing material. The perforated barrel design allows small substrate amalgams to escape and fall to the ground for even distribution. The side clasp design on either side of the barrel drum enhances the functionality of the tool by increasing the durability and efficiency of the substrate contained within the barrel.

### BACKGROUND OF THE INVENTION

### 1. Field of Invention

The present invention relates to a peat moss and top-dressing spreader.

### 2. Description of the Prior Concept

Variations of the peat moss and top-dressing spreader exist as they are a commonly used tool for lawn enthusiasts to use to amend their lawns. Many of these are designed using a common barrel-to-U Joint handle for operation. Some provide various methods for ensuring sediment stays locked within the barrel using latches, clasps, and any other manner of sealing sediment. The perforated barrel designs allow for small amalgams of the substrate to escape and fall to the ground for even distribution.

### SUMMARY OF THE INVENTION

The main object of the present invention is to provide a more efficacious and user-friendly design for sealing in sediment until the proper operation of the “Spreader with Side Clasps” by modifying the way substrate is contained within the perforated barrel.

Additionally, a second main objective is to increase the durability of the spreader with side clasps.

To achieve the above objectives, a modification in the location of the locking clasp to the right and left side of the barrel, rather than affixing them on the face of the perforated barrel. The locking clasp has replaced earlier iterations of the spreader with side clasps. The locking clasps are attached using two machine screws which are fastened by a corresponding nut plate on the inside of the perforated barrel. Furthermore, to aid the function of sealing the sediment inside the mesh barrel 4, a J-hook style lip 12 has been welded to the barrel door within close conjunction to the latching clasp. This modification is preferred as it reduces the amount of contact to the ground provided a more durable design.

### BRIEF DESCRIPTION OF THE DRAWINGS

FIG. 1 is a breakdown of the larger components that make up the anatomy of the current state of this design.

FIG. 2 illustrates the various components used to make the latching clasp possible as a feature of the product.

FIG. 3 is a close-up representation of how the latching side clasps amend the design.

FIG. 4 is a blow-up view to illustrate how the barrel connects to the handle.

### DETAILED DESCRIPTION OF THE PREFERRED EMBODIMENTS

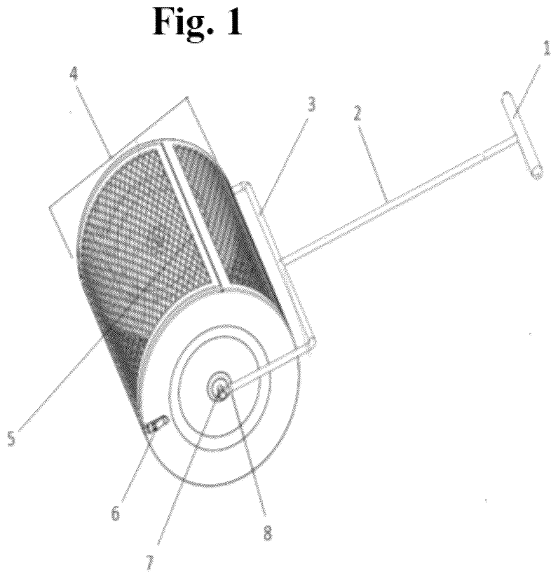

The preferred embodiment of the invention should refer to FIG. 1 for the preceding description. The spreader with side clasps employs a hollow painted steel tube handle with a welded U-joint 3, this handle is welded at 4 points. Starting with the steel hollow handle with an internal diameter of ⅞ inches and a length of twelve inches 1, the handle is connected by a weld point to a square steel tube with a diameter of one inch and an additional 24 inches of length 2, which is joined at the opposite end using a weld point to the U-joint used to connect the handle to the barrel 4. The U-joint 3 extends beyond the length of the mesh barrel 4 at twenty-seven inches to allow the eyelets located at both ends of the U-joint 3 to line up so that the U-joint 3 to mesh barrel assembly can be installed 7. The mesh barrel features two solid metal sides with mesh painted steel framework lining the mess barrel in a dorsal configuration. The mesh barrel has a length of twenty-four inches and a height of fifteen inches for an internal volume capacity of 2.75 cubic feet. Additionally, a mesh gate 5 has been added to allow the user to broadcast sediment directly into the mesh barrel 4. The mesh gate 5 extends to a length of 22.75 inches and a height of fifteen inches. Mounted to each side of the mesh barrel 4 are latching clasps 6 made of stainless steel used to lock the mesh gate 5 in place during operation by putting down force using a clasp arm to create surface tension against a J-hook style latch welded onto the mesh gate 5. This is where the second claim is derived as previous iterations employed clasps on the face of the mesh gate 5, resulting in expeditious deterioration of locking hardware. In the preferred design, the latching clasps 6 have been relocated to the side of the mesh barrel 4 to avoid contact with the ground or other factors that cause hardware deterioration.

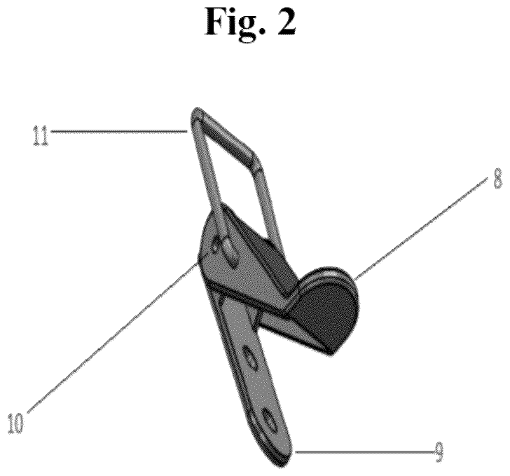

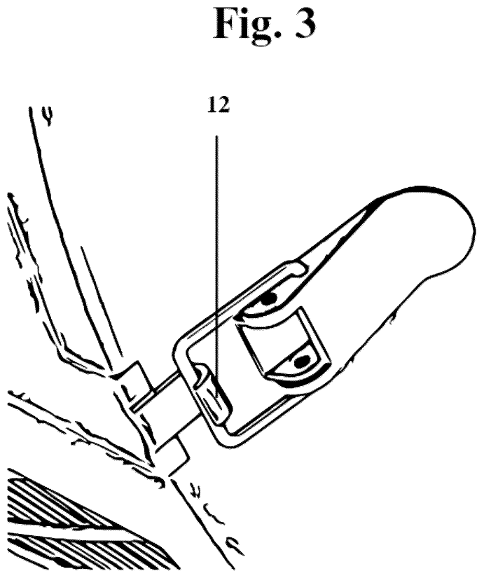

The preferred iteration of the design, referring to FIG. 2, shows a simplistic breakdown of the latching clasp 6 mechanisms used to achieve the design's second claim, to increase the durability of the design. The latching clasp located on the right and left sides of the mesh barrel 4 is made up of four components all of which are made of stainless steel. The latching 7 clasp mounting base 9 features two through holes which are used to install rivets to mount the latching clasp 6 to the side of the mesh barrel 4. On top of the latching clasp mounting base 9 is the ergonomic push tab 8 which connects the latching clasp mounting base 9 using one-inch stainless steel rod 10 to allow the ergonomic push tab 8 to be adjusted forward or backwards 90 degrees. Connected to the ergonomic push tab 9, is the latching clasp arm 11, which is used to create downward force on the J-hook style latch 12 as shown in FIG. 3 to produce the necessary locking effect needed to ensure the mesh gate 5 does not swing ajar during operation.

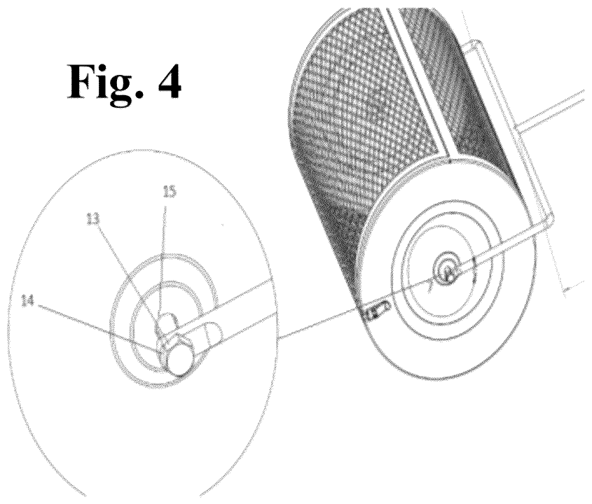

The following description refers to FIG. 4, which illustrates how the mesh barrel 4 is connected to the U-joint 3. The mesh barrel to U-joint assembly 7 employs a protruded through-hole welded to each side of the mesh barrel 4. A clevis pin is inserted through a 5/16 inch through-hole located on both ends of the U-joint 3 into the protruding through-hole welded to the side of the mesh barrel. This clevis pin 13 once properly installed, will then be fastened using a cotter pin 15 and washer 14 to ensure that proper rotation of the mesh barrel 4 can take place, while locking the mesh barrel component in place between the U-joint 3. This design reflects the preferred iteration of the Spreader with Side Clasps to promote the first claim of ensuring a user-friendly design that can be easily assembled using minimal components.

The aforementioned objectives have been met in this preferred iteration of the design as it pertains to both durability and user-friendly functionality claims. These functions have been exemplified through empirical assessments of the product design and by way of testing pain points for consumers. The technical description of this design seeks to establish a well-understood summary of the design so that it can be replicated within the parameters exemplified within this document.

What is claimed is:

1. A peat moss and top-dressing spreader comprising: a barrel for holding peat moss and other top-dressing materials; a plurality of side clasps attached to the left and right side of the mesh cage barrel; a handle attached to the barrel, the handle configured to allow a user to push or pull the spreader across the surface, a U-joint used to connect the handle to the barrel that is attached to the barrel by a pair of two bolts and a screw, and a full-barrel open door with latches on the right and left side of the barrel lip.

2. The peat moss and top-dressing spreader with side clasps of claim 1, wherein the barrel drum design includes the plurality of side clasps on the left and right side of the barrel drum, attached using two machine screws which are fastened by a corresponding nut plate on the side of the perforated barrel, allow for efficient functionality of sealing in sediment inside the mesh barrel.

3. The peat moss and top-dressing spreader with side clasps of claim 1, wherein the plurality of side clasps reduces the amount of contact to the ground when the peat moss and top-dressing spreader with side clasps is mobile dispersing sediment, providing a more durable and efficient design.
